(19) United States
(12) Patent Application Publication
(10) Pub. No.: US 2006/0175252 A1
(43) Pub. Date: Aug. 10, 2006

(54) Two phase anaerobic contact sequencing batch reactor (ACSBR) system for treating wastewater containing simple and complex organic constituents

(76) Inventors: K.C. Upendrakumar, Carmel, IN (US); Thomas C. Bachman, Pewaukee, WI (US); Elizabeth L. Williams, West Allis, WI (US)

Correspondence Address: BOYLE FREDRICKSON NEWHOLM STEIN & GRATZ, S.C., 250 E. WISCONSIN AVENUE, SUITE 1030, MILWAUKEE, WI, 53202, US

(21) Appl. No.: 11/347,621

(22) Filed: Feb. 3, 2006

Related U.S. Application Data
(60) Provisional application No. 60/650,025, filed on Feb. 4, 2005.

(51) Int. Cl. C02F 3/28

(52) U.S. Cl. 210/603; 210/612

(57) ABSTRACT

A two-phase anaerobic treatment system and method for the treatment of wastewaters containing simple and complex organic constituents is provided wherein the complex organic constituents are broken down into simple organic constituents by acidogenic bacteria in a Phase One reactor and the simple organic constituents from the Phase One reactor are converted into biogas, mainly methane, in a Phase Two reactor by methanogenic bacteria. The method includes the steps of feeding wastewater to the Phase One reactor either in an intermittent batch mode or semi-continuous mode, and withdrawing effluent from the Phase One reactor preferably in a batch mode. Effluent from the Phase One reactor is fed to the Phase Two reactor in an intermittent batch mode while effluent from the Phase Two reactor is withdrawn in a batch mode. The method minimizes the transfer of suspended solids from the Phase One reactor to the Phase Two reactor.

### CROSS-REFERENCE TO RELATED APPLICATIONS

This application claims priority from U.S. Provisional Patent Application Ser. No. 60/650,025, filed on Feb. 4, 2005, the entity of which is expressly incorporated by reference herein in its entirety.

### FIELD OF THE INVENTION

The present invention relates generally to wastewater treatment, and more specifically to the treatment of wastewater using a two-phase anaerobic contact sequencing batch reactor system.

### BACKGROUND OF THE INVENTION

For over a century, biological wastewater treatment using various embodiments of the anaerobic process has been practiced. Anaerobic processes possess several advantages over aerobic processes when treating high strength industrial wastewaters. At the same time several drawbacks due to deficiencies in process design or poor operation has led to a disfavor of anaerobic processes over the years.

Recently, several treatment systems have been developed in an attempt to provide innovative solutions to various drawbacks of the anaerobic processes, but they still fall short. The reason for this is that these systems, discussed hereinafter, attempt to provide unique solutions to isolated issues without providing a comprehensive solution.

Existing anaerobic treatment systems are geared towards soluble waste on the one hand and particulate waste on the other. Some examples of soluble waste anaerobic treatment systems include the attached growth systems such as the anaerobic filter, anaerobic fluidized bed and the recently developed granular systems—upflow anaerobic sludge blanket (UASB) and the enhanced granular sludge bed (EGSB) systems. These systems perform optimally on only soluble waste and high concentrations of suspended solids and/or fats, oils and grease in the waste either lead to poor system performance and/or disaggregation of the granules.

On the other hand, suspended growth systems such as the anaerobic contact process and the anaerobic sequencing batch reactor (ASBR), perform well on wastewater with high-suspended solids and/or fats, oils and grease concentrations. But wastewaters high in soluble organic matter negatively affect these systems in terms of volatile acid formation and reactor pH. Consequently, these systems need constant control, or the reactor volume needs to be over-designed to account for the soluble loading.

Anaerobic contact process is a continuous or semi-continuous feed, suspended growth system appropriate for the treatment of high strength industrial wastes including liquids and slurries. The anaerobic contact process system includes an anaerobic reactor where the influent wastewater is thoroughly mixed with the anaerobic microorganisms and a gas collection system. However in addition to the anaerobic reactor, the anaerobic contact process typically uses a degassifier to remove entrapped biogas and a clarifier to settle out the biomass solids. The solids are recycled from the clarifier to the anaerobic reactor to increase the solids retention time.

The ASBR is a batch fed, suspended growth process. The system is operated to achieve the desired level of treatment by sequencing the reactor through four main stages: feed, react, settle and decant. The single reactor may be cycled as frequently as possible while providing the necessary feed, react, settle and decant time. The operating principles for the ASBR are simple.

In the first stage of the ASBR, the feed stage, substrate is batch fed to the reactor. The volume of substrate added to the reactor is determined based on a number of factors including the desired hydraulic residence time (HRT), organic loading rate (OLR), and expected settling characteristics of the sludge. Usually the feed volume is the same as the volume that was decanted as effluent in the decant stage. In an ASBR, the food-to-microorganism ratio (F:M) is the highest immediately after feeding and decreases throughout the cycle until the reactor is fed again. Following the feed stage, the high F:M concentration results in a high driving force for metabolic activity and may increase substrate removal rates in the react stage.

Once the reactor has been fed, the reactor contents are mixed to ensure good distribution of the substrate and to improve the overall performance of the reactor. Continuous or intermittent mixing may also occur during the feed stage. The mixing in the ASBR should be short and gentle, as intense mixing could destroy the anaerobic bioflocs and lead to poor settling. Based on chemical oxygen demand (COD) removal efficiencies, research has indicated that intermittent mixing as opposed to continuous mixing may actually improve the overall performance of the reactors. The length of time required for the react stage is dependent on the influent wastewater characteristics, required effluent quality, biomass concentration and waste temperature. The react stage is the most important stage of the ASBR in terms of the conversion of organic substrate to biogas. At the end of the react cycle, the low F:M concentration results in low gas production and good conditions for biomass flocculation and separation during the settle stage.

After the react stage, the mixing is shut off to allow for biomass separation and liquid clarification. In the ASBR process, the reactor itself acts as the clarifier, eliminating the need for an external clarifier and the need for degasifying the effluent. Since the partial pressure of the biogas remains constant within the reactor, the tendency for biomass solids to float (due to CO2 release) is greatly minimized in the ASBR, resulting in faster solids settling and the ability to process large liquid volumes while maintaining long solids retention times. The length of time required for clarification can vary from 10 minutes to one hour depending on the concentration of biomass solids in the reactor and settleability. The concentration of biomass solids in the reactor affects the settling velocity of the biomass and the ability to achieve a clear supernatant. The settling time must be short enough to wash out the poorly settling biomass, but not so short such that the flocculent biomass is washed out from the reactor.

Once sufficient solids separation has occurred, the clear supernatant is decanted from a fixed port at a predetermined level or by an adjustable or floating weir just beneath the liquid surface. The total volume that is decanted is dependent on the volume of the reactor and the HRT, and is usually equal to the volume that was fed in the feed stage. The time required for decanting depends on the total volume to be decanted and the decanting rate.

One prior art example of a system that combines the advantages of the two systems into one system capable of enhancing the performance in treating both soluble wastes and particulate wastes is the anaerobic sequencing batch reactor disclosed in Dague U.S. Pat. No. 5,185,079 (the '079 patent). The anaerobic sequencing batch reactor (ASBR) of the '079 patent is a suspended growth anaerobic treatment system using a single vessel in lieu of the two vessels required for the prior art anaerobic contact process. The ASBR system operates on a fill and draw basis as shown in FIGS. 1A-1E. Starting from the idle mode, the influent wastewater is added to the vessel 10, which is enclosed by a cover 20, in Step 1, which is the fill mode. Once the liquid level reaches the maximum fill level 22, the fill mode stops, and Step 2, the react mode, starts. In the react mode, the wastewater is agitated within the vessel 10 by a stirring mechanism 12 having an impeller 16 disposed inside the vessel 10 that is connected to a rotor 14 by a shaft 18. Following a variable time interval for the react mode that allows the microorganisms to react with and convert the organic matter, Step 3, the settle mode is engaged. In this mode, the microorganisms separate and settle to the bottom of the vessel 10, leaving a supernatant at the top that can be withdrawn as treated effluent, Step 4, the decant mode.

While the ASBR of the '079 patent enables anaerobic treatment of wastewater via the anaerobic contact process to be performed in a single vessel, the structure and method of the anaerobic treatment process illustrated in the '079 patent has certain drawbacks as well. More particularly, the drawbacks of the '079 patent apparatus and method include:
1) the system is primarily applicable only to wastes containing a high concentration of particulate organic matter such as manure;
2) the system cannot be used in treatment of wastewaters containing high concentrations of both particulate and soluble organic matter;
3) adding the entire batch volume of wastewater during the fill mode when it contains high concentrations of soluble organic matter leads to overloading, which eventually leads to a pH drop due to volatile acid formation and subsequently to a sour reactor;
4) the single reactor does not provide for the most efficient digestion of solids;
5) the system is not applicable to industrial wastewaters containing certain process chemicals which are toxic or inhibitory to methanogens;
6) the solids separation is not efficient because biogas is continuously being produced during settle step, thereby inhibiting settling of suspended solids; and
7) the inefficient conversion of volatile solids to volatile fatty acids and biogas in the system results in higher total suspended solids concentrations and hinders optimum solids settling.

As a result, it is desirable to develop an apparatus and system for anaerobic treatment of wastewaters containing particulate and soluble organic matter via an anaerobic contact process that overcomes or limits the problems caused by the drawbacks listed above for prior art in anaerobic sequencing batch reactors.

### SUMMARY OF THE INVENTION

According to a primary aspect of the present invention, a system for the anaerobic treatment of waste containing high concentrations of either particulate organic matter or soluble organic matter, or both, is provided. The system incorporates a two-phase anaerobic contact sequencing batch reactors operating in multiple feed and react modes, and single settle and decant modes. Anaerobic systems can be operated as single-phase or two-phase systems. Single-phase systems involve only one reactor for the microorganisms to digest the organic matter, whereas two-phase systems separate the hydrolysis and acidogenic, and methanogenic organisms into two separate reactors. Because of the separation of the process into the two parts or phases, the system of the present invention is also highly efficient on wastes containing high concentrations of fats, oils and grease.

In operation of the system of the present invention, the influent waste is fed into a Phase One reactor containing acidogenic bacteria in an initial step in a continuous mode or in a batch mode. The hydraulic retention time in the Phase One reactor in this step varies from 1 to 3 days, such that the time period is sufficient for the acidogenic bacteria to produce volatile fatty acids from the waste in the Phase One reactor, but not enough to convert the volatile fatty acids to methane gas. The continuous mode of operation is suitable for wastes in which a clear solids/liquid interface is not discernible. However, in the alternate mode of operation, i.e., batch, the steps include the fill, react, settle and decant modes as in a sequencing batch reactor, the difference being that this is only an intermediate effluent which is to be treated further by the system.

In the first step, the particulate organic matter is broken down by the acidogenic microorganisms contained within the Phase One reactor into short chain volatile fatty acids. Optimum conditions to maximize this conversion are maintained in the Phase One reactor during the entire length of the first step. The effluent withdrawn from the Phase One reactor at the completion of the first step has very high concentrations of volatile fatty acids, which are subsequently converted to methane gas and other end products in a second step performed in a second, or Phase Two reactor, also formed as an ASBR.

To overcome the deficiencies noted earlier with regard to the operation of the ASBR in the '079 patent in the fill mode, i.e., the pH drop and creation of a sour reactor, the Phase Two reactor is fed multiple times in multiple feed steps.

In the first feed step about 10 to 25 percent of the Phase One reactor effluent is fed to the Phase Two reactor. This is followed by a react step. In the second feed step another 10 to 25 percent of the Phase One reactor effluent is fed to the Phase Two reactor. This is again followed by a react step. This sequence of feed-react steps is followed until the amount of the Phase One reactor effluent to be processed in the Phase Two reactor is exhausted. Following the final feed-react steps, the Phase Two reactor contents are allowed to settle. This promotes separation of the solids, i.e., microorganisms from the liquid. In the next step, the treated total amount of effluent is withdrawn from the Phase Two reactor and discharged to the city sewer or to undergo further treatment before discharge to surface waters.

According to another aspect of the present invention, the system is applicable to wastes containing high concentrations of particulate organic matter or soluble organic matter or both and to wastes containing high concentrations of fats, oils and grease. Further, the system of the present invention is not easily upset by high soluble organic matter as multiple feed steps prevent the instantaneous generation of volatile fatty acids responsible for pH drop and sour reactors. Some of the reasons for this are that the two-phase system is more stable than a single reactor system in treating variable organic loads. Also the acetogenic Phase One reactor provides optimum conditions for efficient digestion of solids and fats, oils and grease, and that acetogens are more resistant to toxic/inhibitory compounds. Therefore, the system is highly suitable for treatment of industrial wastewater containing toxic/inhibitory compounds as influent is fed to Phase One reactor.

According to a further aspect of the present invention, the batch mode of operation, i.e., feed and starve, used for the system of the present invention produces better settling bacterial flocs compared to a continuous system.

According to still another aspect of the present invention, the methanogenic Phase Two reactor provides optimum conditions for conversion of simple organics (volatile fatty acids) into biogas, which enhances the methane production rate and results in a higher biogas methane content compared to a single reactor system. Further, for sugar type wastes, the Phase Two reactor can be operated independently, or without the Phase One reactor.

According to still a further aspect of the present invention, separation of the acetogens and methanogens into two reactors provides a more suitable environment for settling of solids and biomass than a single reactor system. This also reduces the reactor volume required to treat the same organic load by 25 to 50 percent compared to a single stage sequencing batch reactor system.

Numerous other features, aspects, and advantages of the present invention will be made apparent from the following detailed description, taken together with the drawing figures.

### BRIEF DESCRIPTION OF THE DRAWINGS

The drawings illustrate the best mode currently contemplated of practicing the present invention.

In the drawings:

FIGS. 1A-1E are schematic views of the operation of a prior art anaerobic sequencing batch rector system;

FIG. 2 is a schematic view of the two-phase anaerobic contact sequencing batch reactor constructed according to and utilized in the method of the present invention;

FIG. 3 is a schematic view of the operation of the first phase reactor of ther reactor system of FIG. 2 in a continuous mode of operation;

FIGS. 4A-4E are schematic views of the operation of the first phase reactor of the reactor system of FIG. 2 in a batch mode of operation; and

FIGS. 5A-5I are schematic views of the operation of the second phase reactor of the reactor system of FIG. 2 in an intermittent batch mode of operation.

### DETAILED DESCRIPTION OF THE INVENTION

With reference now to the drawing figures in which like reference numerals designate like parts throughout the disclosure, to overcome the deficiencies of this prior art wastewater treatment method discussed previously, a treatment system constructed according to the present invention is indicated generally at 1000 in FIG. 2. The system 1000 utilizes a first reactor 100, and a second reactor 200 in conjunction with one another to perform the wastewater treatment in the system 1000. However, it is also contemplated that the system 1000 can be formed with only one reactor 100 or 200. Each of the reactors 100 and 200 is formed as an anaerobic contact sequencing batch reactor (ACSBR) and includes a mixing or agitating mechanism 300. In a preferred embodiment, each mechanism 300 includes an adjustable speed motor 302 disposed outside of the reactor 100 or 200, that is operably connected to an impeller 304 located within the reactor 100 or 200 by a rotating shaft 306 that extends from the motor 302 into the reactor 100 or 200 for connection to the impeller 304. However, in an alternative embodiment, instead of an impeller 304 and shaft 306, the mechanism 300 for either or both of the reactors 100 or 200 can take the form of a recirculation pump apparatus (not shown) that operates to recirculate the reactor contents within the reactor 100 or 200. Further, any other suitable mixing or agitating mechanism, such as a side or bottom entry mechanism, or other reactor agitator, can be used for the mechanism 300.

The reactors 100 and 200 are also each sealed by a cover 307 on which the motor 302 is preferably disposed and through which the shaft 308 extends that effectively prevents any oxygen from entering the reactors 100 and 200 during the processing of the wastewater within the reactors 100 and 200. However, each reactor 100 and 200 also includes an opening 310 in the cover 307 through which any biogas produced by the operation of the specific reactor 100 or 200 can be collected. Other openings (not shown) are also formed in each of the reactors 100 and 200 to enable influent charging, effluent discharge, and reactor content sampling, as is known in the art and thus needs no further discussion here. The reactors 100 and 200 are also interconnected with one another by suitable tubing or piping 400 that extends from the first reactor 100 to an effluent storage tank 500, and from the storage tank 500 to the second reactor 200.

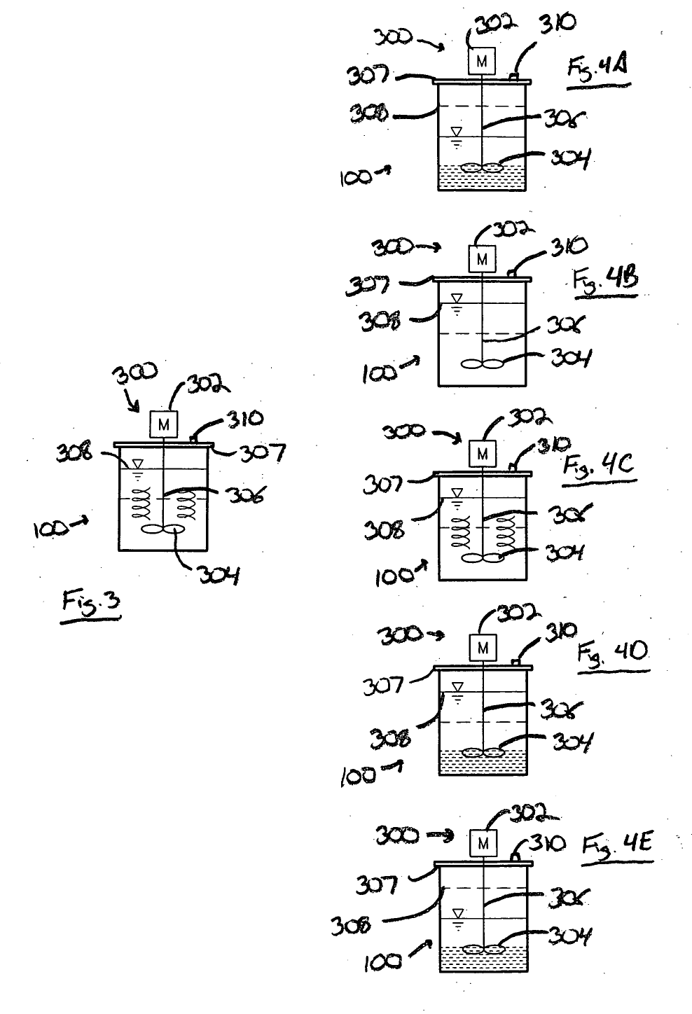

In operation, as best shown in FIGS. 3-4D, wastewater containing both simple and complex organic constituents is charged to the first reactor 100, which contains predominately acidogenic bacteria at optimal conditions. This optimization of the conditions for the acidogenic bacteria in the first reactor 100 can be manually or computer controlled in any known manner, and involves keeping the pH and temperature of the reactor 100 within certain specified parameters. More particularly, for the pH of the reactor 100, the value is maintained between 4.5 and 7.0 standard units, and preferably 5.3 to 6.0 standard units. For the temperature of the reactor 100, the value is kept within either a mesophilic temperature range (i.e., 29° C. to 38° C.) or a thermophilic temperature range (i.e., 49° C. to 57° C.).

After the wastewater is charged to the first reactor 100, the organic constituents in the wastewater are reacted with the acidogenic bacteria in a continuous mode, a semi-continuous mode, intermittent batch mode, or in a batch mode of operation. When operated in the continuous mode, the agitating mechanism 300 is continuously operated as the wastewater is added to the reactor 100 to mix the wastewater with the acidogenic bacteria present in the reactor 100. Alternatively, if the wastewater is added to the reactor 100 in a semi-continuous mode, the wastewater is added continuously to the reactor 100 during a number of several minute intervals while the agitating mechanism 300 is operating, with react steps occurring between the intervals. Each interval lasts preferably less than 25% of the overall feed/react cycle time.

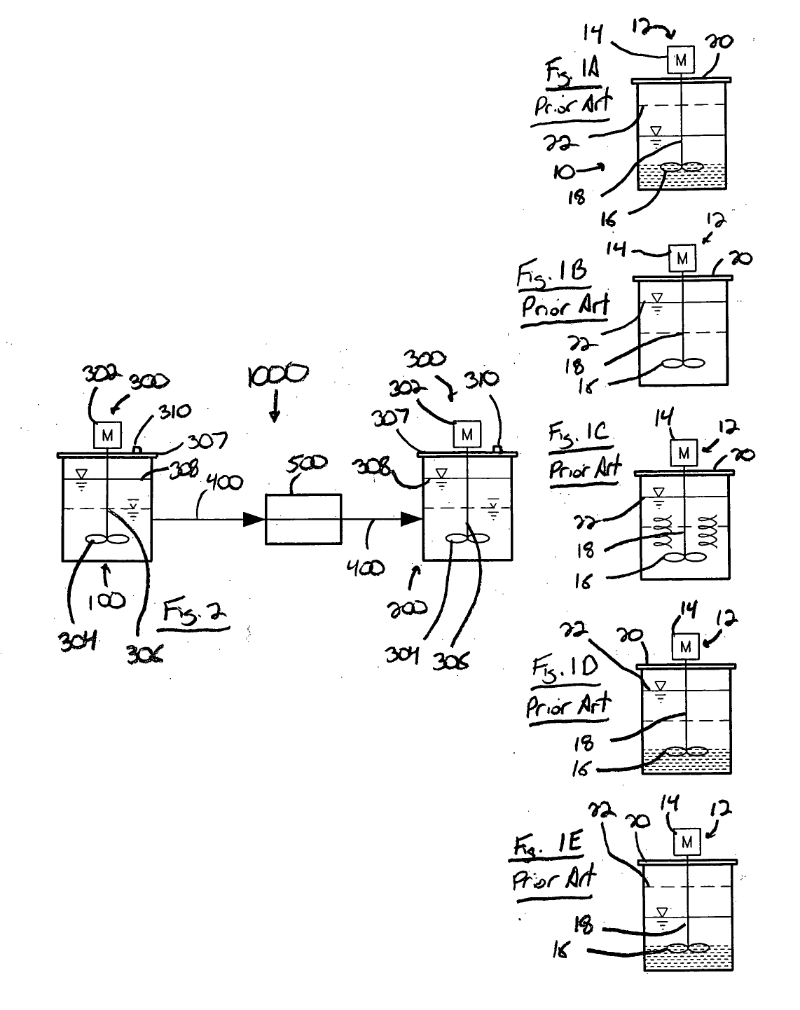

Conversely, in a batch mode, the reactor 100 can be operated either in a simple batch mode or in a intermittent batch mode, similar to the prior art method shown in FIG. 1, where the agitating mechanism 300 is not operated as the wastewater is charged to the reactor 100. More specifically, as shown in FIGS. 4A-4E, in the batch mode of operation, wastewater is added to the rector 100 during a fill mode to a maximum fill level 308, and the mechanism 300 is subsequently operated to react the organic constituents within the wastewater with the acidogenic bacteria present in the reactor 100 in a react mode to break down the complex constituents into more simple constituents. The total amount of wastewater added to the reactor 100, if added in an intermittent batch mode, is fed to the reactor 100 in a number of separate batches, and preferably in 4 to 10 separate batches, without any mixing by the mechanism 300, with react steps occurring in between batches.

However, in all suitable modes of operation, the mechanism 300 is operated to achieve the best dispersion of the acidogenic bacteria within the wastewater, thereby optimizing the breakdown of the complex organic constituents in the wastewater. The mechanism 300 is preferably operated either intermittently at medium or high speeds, or continuously at lower speeds depending on the mode of operation of the reactor. More particularly, in batch or intermittent batch modes of operation, the mechanism 300 is preferably operated at medium or high speeds during the feed cycles only, each lasting preferably 3 to 5 minutes, while in a semi-continuous or continuous mode, the mechanism 300 is continuously operated at lower speeds.

After all of the wastewater has been added and reacted with the acidogenic bacteria in one of the three non-continuous modes, the mechanism 300 is switched off to allow the components to settle within the reactor 100 in a settle mode having a specified duration depending upon one or more factors including, but not limited to, the amount of wastewater charged to the reactor 100, or the particular mode of operation. Prior to entering the settle mode, such as during the react steps, the biogas produced by the conversion of the organic material is removed from the reactor 100 through the opening 310 for use in any other suitable process and to facilitate the settling of the biomass to form the supernatant. In the settle mode, the acidogenic bacteria settle to the bottom of the reactor, along with other solids. The resulting supernatant formed within the reactor 100 is subsequently decanted in a decant mode, leaving the acidogenic bacteria within the reactor 100. Once the supernatant is decanted from the reactor 100, additional wastewater can be charged to the reactor 100 in any of the previously described three non-continuous modes for initiating a subsequent treatment sequence.

Regardless of the particular mode of operation for the first reactor 100, the effluent decanted from the reactor 100 is transferred via suitable piping 400 to the effluent storage tank 500 for use in the phase-two or second reactor 200. The Phase Two or second reactor 200 contains predominately methanogenic bacteria at optimal conditions. This optimization of the conditions for the methanogenic bacteria in the second reactor 200 can be manually or computer controlled in any known manner, and involves keeping the pH and temperature of the reactor 200 within certain specified parameters. For the pH of the reactor 200, the value is preferably maintained between 6.5 and 8.2 standard units, with a value of between 6.8 and 7.5 standard units being especially preferred. For the temperature of the reactor 200, the value is kept within either a mesophilic temperature range, i.e., 29° C. to 38° C. or a thermophilic temperature range i.e., 49° C. to 57° C. In all suitable modes of operation, the mechanism 300 is operated to achieve the best dispersion of the bacteria within the reactor 200. The mechanism 300 is preferably operated either intermittently at medium or high speeds, or continuously at lower speeds depending on the mode of operation of the reactor 200, as discussed previously.

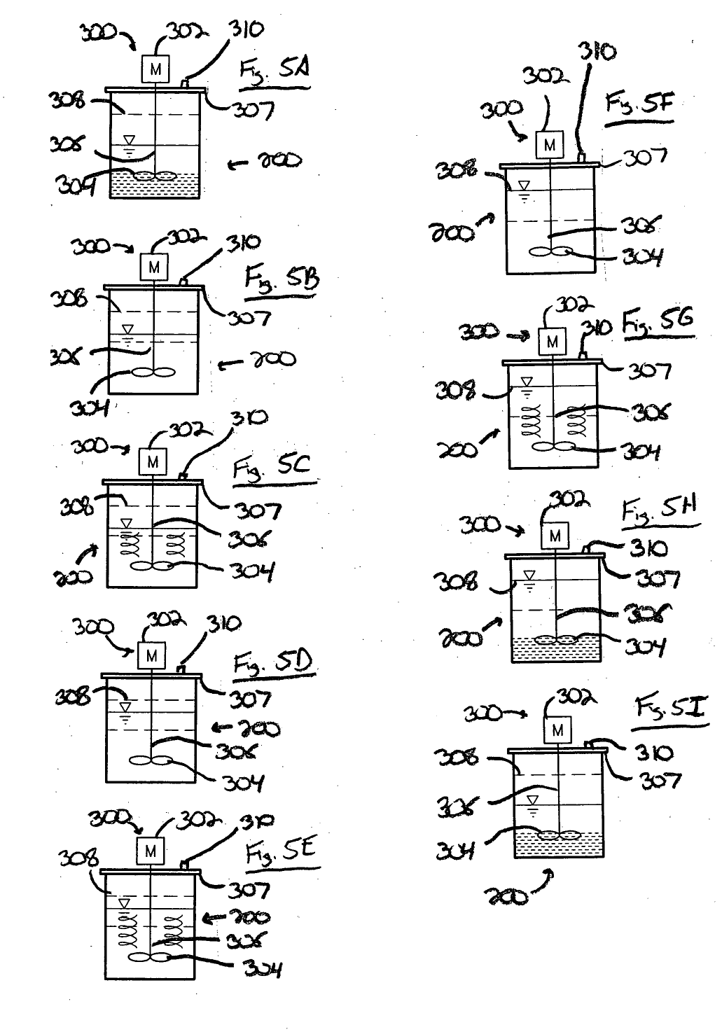

As best shown in FIGS. 5A-5I, the reactor 200 is preferably operated in an intermittent batch mode where the conditions within the reactor 200 are optimized and controlled in a manner similar to the reactor 100 when the reactor 100 is operated in an intermittent batch mode. However, the reactor 200 may also be operated in any of the other three modes as well (i.e., continuous, semi-continuous, or batch modes), if necessary. In the intermittent batch mode of operation, initially, the reactor 200 is charged with an amount of the effluent from the storage tank 500 to a level below the maximum fill level 308 of the reactor 200. The agitating mechanism 300 on the reactor 200 is then operated to react the effluent with the predominant methanogenic bacteria contained within the reactor 200 for a specified period of time to convert the simple organic constituents in the effluent formed in the first reactor 100 into a biogas, such as methane. After the specified time for conducting the react mode has elapsed, an additional amount of the effluent is charged to the reactor 200 from the tank 500, and a second react mode is initiated within the tank 200. This process is repeated until the amount of the effluent from the tank 500 that is added to the reactor 200 reaches the maximum fill level 308 for the reactor 200. The total amount of effluent added to the reactor 200 is fed in a number of separate batches, and preferably in 4 to 10 separate batches, with react steps occurring in between batches. After the final react mode has been completed within the reactor 200, the reactor 200 enters a settle mode to form a supernatant above the methanogenic bacteria, which settle to the bottom of the reactor 200. Prior to entering the settle mode, such as during the react steps, the biogas produced by the conversion of the organic material is removed from the reactor 200 through the opening 310 for use in any other suitable process and to facilitate the settling of the biomass to form the supernatant. After the settle mode has been completed, the supernatant formed within the reactor 200 is decanted and can be discharged into a suitable receiver, such as a city sewer system, or can undergo further treatment before discharge to surface waters. Then, any additional effluent that has been charged to the tank 500 by the operation of the first reactor 100 can be used in a subsequent treatment sequence.

### EXPERIMENTAL

In determining the operational benefits of the system 1000 of the present invention in comparison with the prior art single ASBR system, as illustrated in the '079 patent, the following study was undertaken. The single-phase ASBR and two-phase ACSBR used in this study were fed the same raw cheese wastewater and were operated in parallel to study quantitatively the effect of phase separation on the anaerobic treatment of high strength cheese wastewater at different OLRs and HRTs.

Each system consisted of a 15-centimeter (6-inch) diameter clear PVC reactor, a top-mounted mixer with speed controller, sample ports down the wall of the reactor and openings in the top of the reactor for batch feeding and biogas collection.

The single-phase ASBR had an active liquid volume of 24 liters and an overall height of approximately 147 centimeters (58 inches). The system was operated as a methanogenic reactor with a pH between 7.1 and 7.8 and a HRT greater than 20 days. The single-phase reactor was batch fed raw cheese wastewater and the feed volume varied depending on the desired OLR and strength of the wastewater.

The two-phase ACSBR system consisted of two reactors, each with an active liquid volume of 12 liters and an overall height of approximately 96 centimeters (38 inches). The first reactor was operated as an acidogenic phase and the second reactor was operated as a methanogenic phase. The pH in the acidogenic phase averaged 5.4±0.87 and the HRT was between 2 and 3 days. The acidogenic phase reactor was fed raw cheese wastewater and the feed volume varied based on the desired HRT. In the methanogenic phase, the pH was between 7.1 and 7.8 with a HRT greater than 7 days. The first reactor in the two-phase system was fed raw cheese wastewater, and a portion of the effluent from the first reactor was fed to the second reactor, whereas a portion was wasted. The feed volume for the methanogenic phase reactor varied depending on the desired OLR and strength of the raw wastewater.

The acidogenic and the methanogenic reactors in the ACSBR system were similar, each having a 12-liter working volume. Typically in a two-phase system, the acidogenic reactor is much smaller than the methanogenic reactor since the required HRT for acidogenesis is less than for methanogenesis. However, design of a full-scale wastewater treatment system based on a small bench-scale reactor is complicated due to differences in mixing and settling characteristics (e.g., wall effects and settling depth) that can occur in bench-scale reactors. Therefore, it was decided to construct the acidogenic reactor with the same depth and diameter as the pilot-scale methanogenic reactor. A deeper pilot-scale reactor was assumed to model mixing and settling characteristics of a full-scale tank design better than a smaller bench-scale reactor. To compare the performance of the single-phase and two-phase systems, the overall OLR to the two-phase system was corrected to estimate results as if no wastewater was wasted from the acidogenic reactor.

At the start of the study, all three reactors were seeded with anaerobic digester sludge from an anaerobic contact process treating food ingredient wastewater (Kerry Ingredients Incorporated, Jackson, Wis.). The seed sludge samples were collected from two different locations within the plant, i.e., return sludge from the clarifier and reactor contents. Before seeding the reactors, the two sludge samples were mixed together, allowed to settle and the supernatant was decanted in an effort to thicken the biomass concentration and to achieve a biomass suspended solids (BSS) concentration in the reactors between 24,000 and 26,000 mg/l. The initial BSS concentration of the reactors was 25,000±3,400 mg/l.

The single-phase and two-phase systems were operated on a 1-day feed-react-settle-decant cycle for a total of 85 days. Mixing was performed on an intermittent basis at approximately 60 to 80 RPM to thoroughly mix the reactor contents. Mixers (Stir-Pak Laboratory Mixers, Model 50002-30, Cole Parmer Instrument Company, Vernon Hills, Ill.) connected to a speed controller (Stir-Pak Speed Controller, Model 50002-02, Cole Parmer Instrument Company, Vernon Hills, Ill.) were operated for 8 minutes every 30 minutes during a 20-hour react cycle. The mixers were controlled by a repeat cycle timer (Model C8845, Intermatic Incorporated, Spring Grove, Ill.). Reactor contents settled for 4 hours and then supernatant was manually decanted from the uppermost port for the single-phase reactor and the two-phase reactors, respectively. Batch feeding was performed manually through the top of the reactor at the beginning of the next cycle. On the 22nd day, the settling time in the acidogenic reactor was increased to 20 hours, until day 72 at which time the settling time was returned to 4 hours. The settling time in the acidogenic reactor was increased in an effort to limit solids carry-over to the methanogenic reactor.

Initially, the daily biogas production was measured using a small-scale wet-test gas meter (Rebel Meter, Nashville, Tenn.) in increments of approximately 100 ml. However, due to difficulties with the electronic counters on the meters, a tedlar gas sampling bag (Chemware Laboratory Products, Raleigh, N.C.) was connected to each reactor to collect the biogas as it was generated. At the end of the 24-hour cycle, the volume of biogas was measured by forcing the collected biogas sample through an industrial grade wet-test gas meter (Precision Scientific Company, Chicago, Ill.).

Raw wastewater samples were analyzed at least once a week or once a new sample was received. Effluent samples from the single-phase and the acidogenic and methanogenic reactors of the two-phase system were collected twice a week. Single-phase and two-phase reactor effluent samples were collected from the effluent sampling port after the settling period.

Once the effluent samples were collected, the mixers were operated for approximately 2 to 3 minutes and samples of the reactor biomass were taken from the middle port of each reactor for biomass suspended solids (BSS) and biomass volatile suspended solids (BVSS) analysis.

The raw wastewater was analyzed for total COD (TCOD), soluble COD (SCOD), total suspended solids (TSS), volatile suspended solids (VSS), fats, oil and grease (FOG), pH, alkalinity, volatile fatty acids (VFAs), total and ortho phosphorous (Total P and Ortho P), organic nitrogen (Org. N) and ammonia nitrogen (NH3—N) in accordance with Standard Methods (APHA et. al. 1998). All reactor effluent samples were collected and analyzed twice a week for TCOD, SCOD, TSS, and VSS and once every two weeks for pH, Ortho P, NH3-N, and alkalinity in accordance with Standard Methods (APHA et. al. 1998). Single-phase and the methanogenic reactor effluent samples were analyzed once every two weeks for FOG, Total P, and Org. N and acidogenic reactor effluent samples were analyzed twice a week for VFAs in accordance with Standard Methods (APHA et. al. 1998). Reactor contents were analyzed for BSS, BVSS, and pH. Generally, triplicate measurements were conducted for TCOD and SCOD and the results presented are the average of the triplicate measurements. TSS, VSS, BSS and BVSS analysis were not run in triplicate.

The pH of the raw wastewater, reactor effluents, and reactor contents were measured by a hand-held pH meter (EOMEGA Digital pH Meter, PHH-47, Taiwan) and general purpose electrode (Orion, USA).

VFAs in the raw wastewater and effluent of the acidogenic reactor of the two-phase system were determined twice a week by gas chromatography with separation using a 6 ft.×¼ in.×5.3 mm stainless steel column (100/120 chromosorb W AW for Gow Mac 600) with a helium carrier flow of 50 ml/min and an oven temperature of 150° C.

The volume of biogas produced by every reactor was measured daily and biogas methane content was analyzed throughout the study. The percent methane of the biogas was determined by collecting a gas sample from the sampling bag with a glass microsyringe and injecting a 5 μl sample into a gas chromatograph (GC) with a flame ionization detector (Autosystem, Perkin-Elmer Corp., Norwalk, Conn.). Separation was accomplished by an 8 ft×0.125 in o.d. stainless steel column packed with 1% SP-1000 on 60/80 Carbopack B (Supelco, Inc., Bellefonte, Pa.) and a nitrogen carrier flow of 20 ml/min at an oven temperature of 60° C.

Single Phase System Analysis

The influent and effluent concentrations, and performance, in terms of TCOD, SCOD, TSS and VSS percent removal over the duration of the study was determined. The raw wastewater samples varied greatly in COD and TSS concentration, especially near the end of the study, reaching a COD concentration of greater than 70,000 mg/l and a TSS concentration of 25,000 mg/l. Fluctuations in influent COD and TSS concentrations resulted in variable organic and solids loading rates making it difficult to achieve steady state conditions. Despite this, it appears that fairly constant TCOD, SCOD, TSS and VSS effluent concentrations and removal rates were achieved during the study.

At the beginning of the study, at an OLR of approximately 2 kg COD/m3-day, the average TCOD and SCOD removals were 98% and 99%, respectively, and average TSS and VSS removals were 87% and 91%, respectively.

The influent wastewater FOG concentration averaged 1,200 mg/l with an effluent FOG concentration usually below 100 mg/l. An average FOG removal of 85% was observed over the duration of the study.

The single-phase reactor produced an average of approximately 14 liters of biogas per day (0.59 l/l-day) with an average methane content of 55%. A variety of biogas methane percentages have been reported in the literature, ranging from 20% to between 48% and 57% up to an average of 77±5% as reported in various sources. Research has shown that methane-producing microorganisms function effectively between a pH range of approximately 6.5 and 8.2, with an optimum near a pH of 7.0 (Eckenfelder 1989; Speece 1989). The results of the study illustrated that the methane production decreased as the OLR increased. The average methane production was 0.21±0.08 m³ CH₄/kg COD removed at an OLR of 2 kg COD/m³-day. This value is lower than average methane yield values reported in the literature and the theoretical value of 0.395 m³ CH₄/kg COD removed, but is still significant. At an OLR of 3.6 kg COD/m³-day, the methane production rate decreased to a low of 0.16 m³ CH₄/kg COD removed.

Two Phase ACSBR System Analysis

The goal of the two-phase ACSBR system was to increase the anaerobic biodegradation of the raw cheese wastewater by separating the hydrolysis and acidogenic reactions to within the first phase of the system and the methanogenic reactions to within the second phase of the system. Two identical reactors were operated—an acidogenic reactor and a methanogenic reactor. The raw cheese wastewater was fed to the acidogenic reactor and the effluent from this reactor was fed to the methanogenic reactor. It was believed that the acidogenic reactor would also reduce shock loadings to the methanogenic reactor since it would also act as an equalization tank.

The results of the two-phase ACSBR system were determined by considering the acidogenic and methanogenic reactors as two reactors operated in series as opposed to two separate reactors. As described previously, the acidogenic reactor was fed raw cheese wastewater and a portion of the effluent from this reactor was fed to the methanogenic reactor and a portion was wasted. However, to evaluate the performance of the two-phase ACSBR system, the overall OLR to the two-phase system was calculated as if no wastewater was wasted from the acidogenic reactor and the total detention time was determined by adding the acidogenic reactor and methanogenic reactor detention times. The effluent of the methanogenic reactor was considered the final effluent of the two-phase ACSBR system.

The biogas and methane production rates for the two-phase ACSBR system were estimated by adding the daily biogas produced from the acidogenic and methanogenic reactors and multiplying by the biogas methane content for each reactor. Although the acidogenic reactor produced a fair amount of biogas, the methane content was fairly low (less than 1%) and therefore contributed very little to the overall methane production rate and biogas methane content.

The overall removal efficiencies for the two-phase ACSBR system were reasonably high, with an average TCOD and SCOD removal of 96% and 98% and an average TSS and VSS removal of 86% and 89%, respectively. The TCOD and SCOD removal efficiencies were fairly constant throughout the study, despite changes in OLR and solids loading rate. However, the TSS and VSS removal efficiencies decreased around day 40 and day 75, as the OLR and solids loading rate to the system increased. On day 40, the OLR increased to 3.2 kg COD/m³-day and the solids loading rate increased to 0.9 kg TSS/m³-day, which resulted in a high effluent solids concentration and thus, a decrease in solids removal. In addition, near the end of the study, the OLR increased to 4.6 kg COD/m³-day and the solids loading rate increased to 2.0 kg TSS/m³-day, which also resulted in decreasing solids removal efficiencies. The overall TSS and VSS destruction rates for the two-phase system were 93% and 94%, respectively.

Several differences between the performance of the acidogenic and methanogenic reactors were observed. Firstly, there was little or no removal of TCOD, SCOD, TSS or VSS in the acidogenic reactor compared with an average removal of greater than 86% of these parameters in the methanogenic reactor. It was expected that the TCOD and SCOD concentrations in the acidogenic reactor would not decrease significantly, but that the effluent SCOD concentration may actually increase as the total VFA concentration increased within the reactor. A slightly higher SCOD concentration was measured in the acidogenic reactor effluent as compared to the influent wastewater SCOD concentration, but the means were determined not to be statistically different. Similarly, low TSS and VSS removal rates in the acidogenic reactor were observed. However, the acidogenic reactor did remove greater than 50% of the FOG concentration in the raw cheese wastewater, substantially decreasing the FOG loading to the methanogenic reactor, which was especially important as the cheese wastewater reached a FOG concentration of 13,000 mg/l. In addition, a 66% increase of NH3-N concentration was realized in the acidogenic reactor compared to an insignificant increase in the methanogenic reactor effluent.

The change in the overall biogas production rate with OLR shows that the biogas production rate is proportional to the OLR. The methane yield in terms of m³ CH₄ per kg COD removed in the two-phase system was approximately 84% of the theoretical maximum yield. Biogas and methane production rates between the acidogenic and methanogenic reactors were also compared. Due to the low methane content of the biogas from the acidogenic reactor and the high methane content in the biogas of the methanogenic reactor, it can be concluded that good separation of the two phases was achieved.

The raw cheese wastewater characteristics and results of the single-phase and two-phase systems are presented in Table 1. Although the overall average HRT, OLR, and pH for both systems were approximately the same throughout the duration of the study, it appears that the two-phase system consistently provided a higher quality effluent, in terms of TCOD, SCOD, TSS, VSS, FOG, and Total P concentrations, than the single-phase system.

TABLE 1
Comparison of the single-phase and two-phase reactors.

| | Raw | Single-phase | Two-phase |
|---|---|---|---|
| Parameter | Wastewater | System | System |
| Temperature | nd | 35 | 35 |
| (° C.) | | | |
| Hydraulic | na | 22 ± 13 | 20 ± 17 |
| retention | | | |
| time (day) | | | |
| Organic | na | 1.8 ± 0.78 | 2.0 ± 1.1 |
| loading rate | | | |
| (kg COD/m³-day) | | | |
| pH | 4.5 ± 1.0 | 7.5 ± 0.2 | 7.6 ± 0.2 |
| TCOD (mg/l) | 38,000 ± 13,000 | 2,500 ± 3,100 | 1,300 ± 1,500 |
| SCOD (mg/l) | 22,000 ± 7,600 | 510 ± 380 | 500 ± 250 |
| TSS (mg/l) | 11,000 ± 6,300 | 970 ± 1,500 | 820 ± 1,100 |
| VSS (mg/l | 10,000 ± 5,700 | 690 ± 910 | 620 ± 800 |
| Total P (mg/l) | 430 ± 100 | 230 ± 400 | 60 ± 44 |
| Ortho P (mg/l) | 230 ± 120 | 12 ± 13 | 6.1 ± 5.0 |
| Org. N (mg/l) | 1,000 ± 130 | 320 ± 450 | 110 ± 100 |
| NH₃—N (mg/l) | 380 ± 260 | 810 ± 250 | 810 ± 260 |
| FOG (mg/l) | 3,000 ± 4,500 | 140 ± 300 | 96 ± 97 |
| VFA | 4,900 ± 2,000 | nd | nd |
| (mg/l as | | | |
| acetic acid) | | | |
| Biogas | na | 0.59 ± 0.38 | 0.75 ± 0.50 |
| production | | | |
| rate (l/1-day) | | | |
| Methane | na | 0.33 ± 0.21 | 0.45 ± 0.30 |
| production | | | |
| rate (l/1-day) | | | |
| Methane | na | 0.17 ± 0.13 | 0.20 ± 0.09 |
| production | | | |
| rate | | | |
| (m³/kg CODr) | | | |
| Biogas | na | 55 ± 5 | 66 ± 14 |
| methane | | | |
| content (%) | | | |

nd: not determined,
na: not applicable.

Both the single-phase and two-phase systems achieved high TCOD and SCOD removal efficiencies throughout the study. As presented in Table 1, the single-phase system achieved an average TCOD and SCOD removal rate of 93% and 98%, respectively. The two-phase ACSBR system achieved overall average TCOD and SCOD removal rates of 96% and 98%, respectively. Although the average TCOD and SCOD removals for both systems were above 90%, the removal efficiencies of the two-phase system were more consistent throughout the study despite changes in raw cheese wastewater composition. Near the end of the study, the TCOD removal efficiency of the single-phase system began to decline to a low of 66% as the influent COD concentration increased to greater than 70,000 mg/l and the FOG concentration reached 13,000 mg/l. However, treating the same cheese wastewater, the two-phase ACSBR system TCOD removal efficiency declined more steadily, but was still approximately 90%. The TSS and VSS removal efficiencies followed a similar trend. Around day 40, the single-phase system effluent TSS and VSS concentrations increased to approximately 15,000 mg/l and 8,000 mg/l, respectively, decreasing the percent TSS and VSS removed to approximately zero. However, although the two-phase ACSBR system performance also declined around day 40, the system was able to maintain TSS and VSS removal efficiencies at almost 80%.

Nearing the end of the study, the single-phase system performance began to decline rapidly as TCOD, SCOD, TSS and VSS effluent concentrations increased. At the same time, the two-phase ACSBR system TCOD and SCOD removal efficiencies remained greater than 80%, but the TSS and VSS removal efficiencies declined more gradually. As stated previously, the acidogenic reactor reduced the FOG loading to the methanogenic reactor by greater than 50%, potentially making the methanogenic reactor and, thus, the two-phase ACSBR system more stable to fluctuating wastewater FOG concentrations as the acidogenic reactor acted as a FOG trap. In addition, it was suggested that potentially toxic constituents might have been present in certain wastewater samples resulting in decreased performance of the single-phase and two-phase systems. It appears that the two-phase ACSBR system was not as affected by these wastewater samples as the TCOD, SCOD, TSS and VSS removal efficiencies did not decrease as rapidly as in the single-phase system due possibly to the presence of the acidogenic reactor in the two-phase system.

The two-phase ACSBR system produced more biogas and methane per liter of reactor volume over the course of the study as presented in Table 1. In addition, the methanogenic reactor of the two-phase ACSBR system produced a biogas with a higher methane content (66%) and therefore the methane yield observed for the two-phase system was greater than the methane yield observed for the single-phase system. The methane production rate for the single-phase and two-phase systems was 43% and 51% of the theoretical methane yield, respectively. Based on the data presented in Table 1, phase separation enhanced the methane yield observed and the percent methane realized in the biogas produced in the anaerobic treatment of raw cheese wastewater.

Various alternatives are contemplated as being within the scope of the following claims particularly pointing out and distinctively claiming the subject matter regarded as the invention.

What is claimed is:

1. A method for treating wastewater containing simple and complex organic constituents, the method comprising the steps of:
a) providing a treatment system including a first reactor containing a first type of microorganism and a second reactor containing a second type of microorganism;
b) charging the first reactor with an amount of the wastewater to form an effluent; and
c) charging the second reactor with the effluent from the first reactor.

2. The method of claim 1 wherein the step of charging the first reactor with the wastewater comprises the steps of:
a) introducing the wastewater into the first reactor; and
b) operating the first reactor.

3. The method of claim 2 wherein the step of operating the first reactor comprises operating the first reactor in a mode selected from the group consisting of: batch mode, intermittent batch mode, continuous mode and semi-continuous mode.

4. The method of claim 2 wherein the step of operating the first reactor comprises operating the first reactor in an intermittent batch mode with between 4 and 10 batches.

5. The method of claim 2 wherein the step of operating the first reactor comprises operating the first reactor in a semi-continuous mode having a feed/react cycle, wherein the feed portion of the feed/react cycle lasts approximately 25% of the total time for the feed/react cycle.

6. The method of claim 2 further comprising the step of clarifying the wastewater and the first type of microorganism to form the effluent after operating the first reactor.

7. The method of claim 6 further comprising the step of removing the effluent from the first reactor to a storage tank.

8. The method of claim 7 wherein the step of charging the second reactor comprises introducing the effluent from the storage tank into the second reactor.

9. The method of claim 2 further comprising the step of maintaining the first reactor at optimum conditions for the first type of microorganism after introducing the wastewater into the first reactor.

10. The method of claim 9 wherein the first type of microorganism is an acidogenic microorganism, and wherein the step of maintaining the first reactor at optimum conditions comprises the steps of:
a) maintaining the pH in the first reactor between 4.5 to 7.0 standard units; and
b) maintaining the temperature in the first reactor in the mesophilic temperature range or in the thermophilic temperature range.

11. The method of claim 7 further comprising the step of recharging the first reactor with additional wastewater after removing the effluent.

12. The method of claim 1 wherein the step of charging the second reactor with the effluent comprises the steps of:
a) introducing the effluent into the second reactor; and
b) operating the second reactor.

13. The method of claim 12 wherein the step of operating the second reactor comprises operating the second reactor in a mode selected from the group consisting of: batch mode, intermittent batch mode, continuous mode and semi-continuous mode.

14. The method of claim 13 wherein the step of operating the second reactor comprises operating the second reactor in an intermittent batch mode with between 4 and 10 batches.

15. The method of claim 12 further comprising the step of maintaining the second reactor at optimum conditions for the second type of microorganism after introducing the effluent into the second reactor.

16. The method of claim 15 wherein the second type of microorganism is a methanogenic microorganism, and wherein the step of maintaining the second reactor at optimum conditions comprises the steps of:
a) maintaining the pH in the second reactor between 6.5 to 8.2 standard units; and
b) maintaining the temperature in the second reactor in the mesophilic temperature range or in the thermophilic temperature range.

17. The method of claim 11 further comprising the step of clarifying the effluent and the second type of microorganism to form a supernatant after operating the second reactor.

18. The method of claim 17 further comprising the step of discharging the supernatant from the second reactor after clarifying the effluent.

19. The method of claim 18 wherein the step of discharging the supernatant from the second reactor comprises discharging the supernatant in a batch mode.

20. The method of claim 18 further comprising the step of recharging the second reactor with additional effluent after discharging the supernatant.

21. The method of claim 12 further comprising the step of removing an amount of biogas generated in the second reactor from the second reactor after operating the second reactor

22. The method of claim 1 wherein the steps of charging the first reactor with the wastewater and charging the second reactor with an effluent from the first reactor occur simultaneously.

23. The method of claim 1 wherein the first reactor and the second reactor are formed by a single reactor.
